(19) United States
(12) Patent Application Publication
(10) Pub. No.: US 2022/0091352 A1
(43) Pub. Date: Mar. 24, 2022

(54) FIBER IDENTIFICATION SCHEME FOR HIGH FIBER COUNT CONFIGURATIONS

(71) Applicant: Corning Research & Development Corporation, Corning, NY (US)

(72) Inventor: Michael Rhea Ellwanger, Hickory, NC (US)

(21) Appl. No.: 17/484,362

(22) Filed: Sep. 24, 2021

Related U.S. Application Data
(60) Provisional application No. 63/082,597, filed on Sep. 24, 2020.

(51) Int. Cl. G02B 6/44

(52) U.S. Cl. CPC G02B 6/447

(57) ABSTRACT

An optical fiber cable includes a cable jacket defining a cable core, and a plurality of fiber bundles extending longitudinally through the core. Each fiber bundle comprises a plurality of optical fibers and a combination of color schemes, one color scheme that uniquely identifies each individual fiber by a particular base color, and a second color scheme that uniquely identifies each individual bundle based on a common color of one element in the bundle.

### CROSS-REFERENCE TO RELATED PRIORITY APPLICATION

This application claims the benefit of priority under 35 U.S.C. § 120 of U.S. Application Ser. No. 63/082,597, filed Sep. 24, 2020, the content of which is relied upon and incorporated herein by reference in its entirety.

### BACKGROUND

In optical cable systems, it is necessary to uniquely identify every fiber in a cable. This is required because a fiber on one end of a cable needs to be associated with that same fiber on another end, especially important when the user of the cable splices the fibers to another cable or attaches connectors to the ends of the fiber. The user needs to know along which fibers in the cable specific signals are being sent.

In most cables, a coloring layer applied to the fiber provides some identification. There are 12 commonly used colors for optical fibers. If it is necessary to identify more than 12 fibers, the fibers can be formed into logical groupings of these 12 colors into subunits. For example, a buffer tube may be produced which can accommodate 12 fibers, each fiber having a unique color. If the tubes are colored with the same 12 colors, that creates quite easily, 144 uniquely identifiable fibers. These tubes are then usually stranded together in a cable structure. To expand identification beyond 144 fibers, a black ring mark can be applied to a fiber to easily double the number of unique fibers in a group from 12 to 24. In addition, the buffer tubes can also be ring marked or striped to create additional unique tubes.

Another method of grouping colored fibers for use in cable systems which is to place fibers in a planar array, creating what is known as a ribbon. A ribbon contains 12 uniquely colored fibers placed side-by-side. Those ribbons are then adhered to each other in a flat format, usually involving a UV-cured matrix material. To distinguish one ribbon from another, the ribbons can be printed with a number. Many ribbons are stranded together to create a ribbon stack within the cable. Such structures or combinations of these structures are commercially available with thousands of uniquely identifiable fibers.

In the unique case of cables for use in a submarine environment, stranding of fibers or cable subcomponents is not desired. Stranding creates a fiber path length which is longer than the cable. A longer path length for the fiber increases the end to end attenuation for a cable of a given length. For this reason, fibers in a submarine cable, which tend to be extremely long, are usually positioned within a central tube. There are no subunits in these cables from which identifiable groupings can be made. The only identifying feature is the color of the fiber. This conventionally has limited the number of fibers to about 20. Ring marking has been proposed as a means to double the number of unique fibers in these cables, but ring marking introduces an attenuation penalty, something which cannot be tolerated in long-haul submarine optical cable systems. As such, there is a need for an identification scheme to uniquely identify a higher count of fibers to be used with long-haul cables, such as those typically used in a submarine environment.

### SUMMARY

In accordance with aspects of the present disclosure, a long-haul cable (e.g., a cable having lengths measured in hundreds or thousands of kilometers) may include bundles of colored fibers. A combination of specific colors creates multiple uniquely identifiable bundles. The individual fibers within each bundle are then further unique identifiers. For example, a white fiber in the blue/white bundle as an example using two-fiber bundles. In the case of two-fiber bundles, using n unique colors, a total of (n²−n) unique fibers can be identified. For three-fiber bundles, there would be even more unique combinations.

Additional features and advantages will be set forth in the detailed description that follows, and in part will be readily apparent to those skilled in the art from the description or recognized by practicing the embodiments as described in the written description and claims hereof, as well as the appended drawings.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. The patent or application file contains at least one drawing executed in color. Copies of this patent or patent application publication with color drawing(s) will be provided by the Office upon request and payment of the necessary fee. In the drawings:

FIG. 1 depicts a conventional color scheme for optical fibers;

FIG. 2 depicts an expanded version of the conventional color scheme of FIG. 1;

FIG. 3 depicts a series of fiber bundles having a unique fiber identification scheme, in accordance with aspects of the present disclosure;

FIG. 4 depicts a series of fiber bundles having a unique fiber identification scheme, in accordance with yet other aspects of the present disclosure; and

FIG. 5 depicts an optical fiber cable having bundles in accordance with aspects of the present disclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

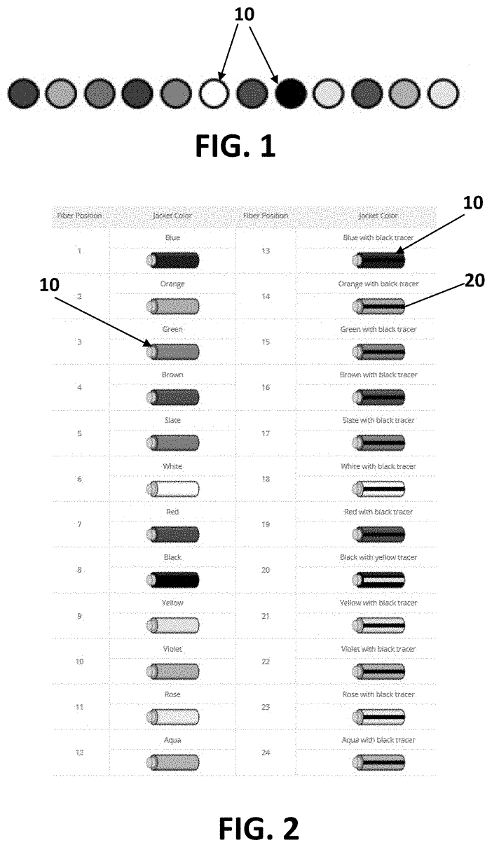

FIG. 1 illustrates a set of conventional single fibers 10. The optical fibers discussed herein include optical fibers that may be flexible, transparent optical fibers made of glass or plastic. The fibers may function as a waveguide to transmit light between the two ends of the optical fiber. The optical fibers include a transparent core surrounded by a transparent cladding material with a lower index of refraction. Light may be kept in the core by total internal reflection. Glass optical fibers may comprise silica, but some other materials such as fluorozirconate, fluoroaluminate, and chalcogenide glasses, as well as crystalline materials, such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage and/or provides distinguishing markings. These coatings may be UV-cured urethane acrylate composite materials applied to the outside of the optical fiber during the drawing process. The coatings may protect the strands of glass fiber and typically are colored as shown to ease identification. In addition, the fibers may be arranged in parallel with a secondary matrix surrounding two or more fibers to form a fiber ribbon. Conventional ribbons are most commonly found in 12-fiber arrays with each fiber colored according to a position.

As shown in FIGS. 1 and 2, the typical coloring of fibers 10 includes twelve identifying colors, which may include blue, orange, green, brown, slate, white, red, black, yellow, violet, rose and aqua. As shown in FIG. 2, an additional marking 20, such as a ring or stripe, may be used to uniquely identify up to twenty four fibers, in essence two sets of 12 fibers having the original 12 color coatings.

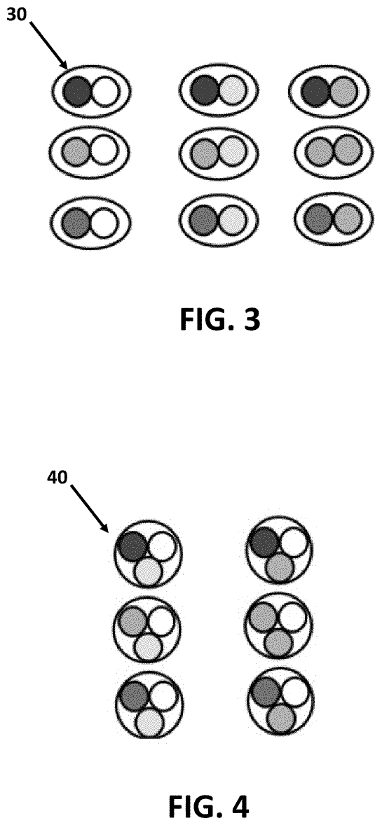

As shown in FIG. 3, using fiber bundles 30 with color combinations provides an identification scheme for cables with a much greater number of uniquely identifiable fibers, even when using the same number of base colors. For example, by arranging the fibers into two-fiber bundles, one fiber of the first set of 12 two-fiber bundles can always be white as shown in the left column of FIG. 3, or one can always be yellow as shown in the middle column of FIG. 3. Thus, one can identify the white fiber in the blue-white bundle or the orange fiber in the orange white bundle, for example. In the case of two-fiber bundles, using n unique colors, a total of (n²−n) unique fibers can be identified. For three-fiber bundles, there would be even more unique combinations (see, e.g., FIG. 4). For example, one could identify the blue fiber of the white-yellow bundles shown in the left column of FIG. 4.

In accordance with yet other aspects of the present disclosure, the two-fiber bundles 30 shown in FIG. 3 or the three-fiber bundles 40 shown in FIG. 4 may be bundled together by a common matrix, a thin film binder, or another suitable means for segregating one group of fibers from another group of fibers. The matrix or binder material used to group the fibers may be tinted with a color to add another means for further distinguishing and identifying a particular fiber within a specific group of fibers, the group being identified by the coloring of the matrix or binder. The material may be transparent or semi-transparent and tinted to a degree that allows simultaneous identification of the fibers contained within the matrix or binder material.

Although indicated above and shown in the figures as having twelve base colors, there may be up to 24 individual base colors, and combined with separate ring marks, it is possible to achieve up to 48-fiber count identification of single fibers in a cable. By grouping into multi-fiber bundles, such as the 2-fiber ribbon concepts disclosed herein, the number of fibers that can be uniquely identified in a cable are significantly enhanced. This then allows fiber configurations with 96, or even more, fibers to be designed wherein each individual fiber can be easily identified, for example, at each end of a cable.

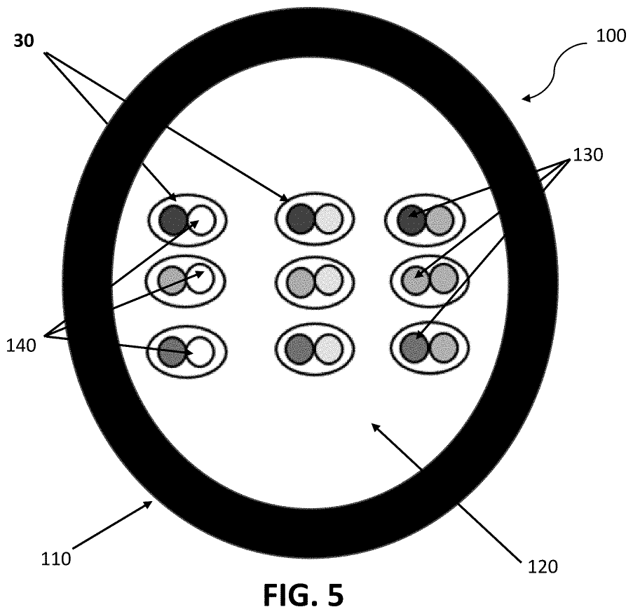

FIG. 5 illustrates an optical fiber cable 100 incorporating fiber bundles 30 with optical fibers colored in accordance with aspects of the present disclosure. The optical fiber cable may include a tube or jacket 110 that protects and defines a cable core 120. The cable core may include the fiber bundles 30 along with other conventional cable core elements, such as strength elements, water blocking materials, or armor (not shown). The plurality of fiber bundles 30 extend longitudinal through the cable core 120. Each fiber bundle may comprise a plurality of optical fibers and a combination of color schemes, a first color scheme 130 being the base color that uniquely identifies an individual fiber, and a second color scheme 140 that uniquely identifies each individual bundle based on a common color of one element in the bundle. Although shown with substantial free space in the cable core 120, the fiber bundles 30 could be provided in the core in a highly dense arrangement with limited free space. In accordance with yet other aspects of the present disclosure, the fiber bundles 30 could be arranged in a stranded configuration with each other, or stranded around a central strength member.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, the cable comprising:
a cable jacket defining a cable core;
and a plurality of fiber bundles extending longitudinally through the core, wherein each fiber bundle comprises a plurality of optical fibers and a combination of color schemes, a first color scheme being a base color that uniquely identifies an individual fiber, and a second color scheme that uniquely identifies each individual bundle based on a common color of one element in the bundle.

2. The optical fiber cable of claim 1, wherein the base color is selected from a group of base colors including blue, orange, green, brown, slate, white, red, black, yellow, violet, rose and aqua.

3. The optical fiber cable of claim 1, wherein the common color is selected from a group of base colors including blue, orange, green, brown, slate, white, red, black, yellow, violet, rose and aqua.

4. The optical fiber cable of claim 3, further comprising a ring mark on the element in each individual bundle having the common color.

5. The optical fiber cable of claim 1, wherein the plurality of optical fibers comprises two optical fibers, wherein a first optical fiber is colored according to the first color scheme and a second optical fiber is colored according to the second color scheme.

6. The optical fiber cable of claim 1, wherein a binder material is used to segregate the plurality of optical fibers into each respective fiber bundle.

7. The optical fiber cable of claim 6, wherein the binder material is a thin film binder.

8. The optical fiber cable of claim 6, wherein the binder material is tinted or provided with a colored identification.

9. The optical fiber cable of claim 8, wherein the binder material is semi-transparent to allow simultaneous identification of the fibers contained within the binder material.

10. The optical fiber cable of claim 1, wherein the plurality of optical fibers includes at least ninety six optical fibers.
